(19) United States
(12) Patent Application Publication
(10) Pub. No.: US 2026/0120477 A1
(43) Pub. Date: Apr. 30, 2026

(54) COMPUTER-IMPLEMENTED METHOD FOR CLASSIFICATION OF AT LEAST AN OBJECT IN AN ENVIRONMENT OF A VEHICLE

(71) Applicant: Robert Bosch GmbH, Stuttgart (DE)

(72) Inventors: Felicia Ruppel, Renningen (DE); Florian Drews, Renningen (DE); Jasmine Richter, Renningen (DE); Johan Vertens, Freudenstadt (DE); Dennis Nienhueser, Renningen (DE); Elizabeth De Benedictis, Stuttgart (DE); Florian Faion, Staufen (DE); Lars Rosenbaum, Lahntal (DE); Rafael Eduardo Salgado Mejia, Renningen (DE); Thomas Nuernberg, Leonberg (DE); Tobias Baer, Pfinztal (DE); Yakov Miron, Haifa (IL)

(21) Appl. No.: 18/952,456

(22) Filed: Nov. 19, 2024

(30) Foreign Application Priority Data
Oct. 24, 2023 (DE) 10 2023 210 494.6

(51) Int. Cl. G06V 20/58; G06V 10/764; G06V 10/80; G06V 10/82

(52) U.S. Cl. CPC G06V 20/58; G06V 10/764; G06V 10/80; G06V 10/82

(57) ABSTRACT

A computer-implemented method for classification of at least one object in an environment of a vehicle. The method includes: collecting first data from a first sensor within a first data collecting frame; collecting second data from at least a second sensor within a second data collecting frame; determining a first object representation using the first data; determining a second object representation using the second data; updating the first and/or second object representation depending on an arrival of third data from the at least second sensor collected in a third data collecting frame after the first data collecting frame; fusing the first and second representation to determine an updated representation of the object based on the received data; applying the updated representation for training the data-driven model as input data for a data-driven model to obtain output data containing an information about a classification of the detected object.

### CROSS REFERENCE

The present application claims the benefit under 35 U.S.C. § 119 of German Patent Application No. DE 10 2023 210 494.6 filed on Oct. 24, 2023, which is expressly incorporated herein by reference in is entirety.

### FIELD

The present invention relates to a computer-implemented method for classification of at least an object in an environment of a vehicle

### BACKGROUND INFORMATION

Current approaches for sensor fusion assume a certain grid around an ego vehicle (a regular grid). This grid is often referred to as the Birds Eye View (BEV) grid having a constant size grid around the vehicle. The 3D native sensors, e.g. Lidar, Radar, provide their information with respect to the ego vehicle in 3D. As such, the projections to this BEV grid is straight forward. In order to fuse the camera reading, additional process is needed to project the information from the 2D camera pixels onto the 3D BEV grid.

However, using such a grid to detect, to classify or to locate objects in an environment of the vehicle has some limitations: It tries to represent sparse information about the object in the vicinity of the ego vehicle in a dense grid. This representation is redundant as most of the grid is left unoccupied and requires a large memory footprint. As such, it will not scale with range in case the user wishes to increase the detection ranges for a given sensor setup. Further, the grid assumes some synchronized data tuples where that data from all the sensors is assumed to arrive at the same time and the BEV model receives the already fused information as one measurement.

A further aspect in this context when detection an object by using a sensor-fusion approach is the way how to train models in order to automate the object detection by use of deep learning (DL) and supervised learning (SL).

Current methods for deep learning (DL) in the context of supervised learning (SL) include some training data and some corresponding labels for training. The training data is fed to the model to produce some model predictions and these predictions are compared to the labels via some loss score. Current SL methods load a batch of data. In current approaches the data batch is represented by data samples that are fixed in length, as the model is aware that the data should arrive at some known time at some known size, e. g, number of images in the case of a video application, etc.

For this, in the related art, an image recognition task for detection an object is described, where data is loaded synchronously to the model. This means that the model usually waits for the GPU to load a pre-defined number of images to the memory. Once this is done, it is passed to the model (either directly or to the GPU and then to the model). The disadvantage of this approach here is that the model waits for the data, and once the data is loaded, the model is activated. This results an inefficient process of object detection.

There is a need to address these issues.

### SUMMARY

The present invention provides an improved concept for improving the detection of at least an object in an environment of a vehicle.

The object of the present invention may be solved curtain features of the present invention disclosed herein.

In a first aspect of the present invention, there is provided a computer-implemented method for classification of at least an object in an environment of a vehicle using a sensor fusion-based approach and a data-driven model. According to an example embodiment of the present invention, the method comprises the following steps:
collecting first data from a first sensor within a first data collecting frame;
collecting second data from at least a second sensor within a second data collecting frame;
determining a first object representation using the first data;
determining a second object representation using the second data;
updating the first object representation and/or the second object representation depending on an arrival of third data from the at least second sensor that has been collected in a third data collecting frame after the first data collecting frame;
fusing the first representation and the at least second representation to determine an updated representation of the object based on the received data;
applying the updated representation for training the data-driven model as input data for the data-driven model to obtain output data containing an information about a classification of the detected object.

In other words, a main feature of the present invention is that measurement data arriving or coming from a sensor device, e.g., a radar sensor, is used to update a current object representation or object list representation, which could be for example, a track. It should be noted in this context that the latent representation of the object list includes the data about the localization and the classification of this object list.

According to an example embodiment of the present invention, a system of a vehicle having multiple sensor devices, therefore, has multiple object representations, wherein each object representation corresponds to a certain sensor device. Each time new sensor data is generated or arrives, this data is used to update only the corresponding object representation, but not other object representations corresponding to other sensor devices. In this way, fusion or merging of different object representations to obtain a final object classification of the object and/or object localization is made more efficient, as relevant features or information of each of the sensor devices are not neglected.

This approach of the present invention leads to various advantages.

First, a common regular BEV grid of a certain size as it is used in the prior art when different sensor devices are merged is not necessary, as the present invention allows to scale detection ranges depending on the usage of the sensor type.

Second, the present invention does not require to receive data from sensor devices in a synchronous manner to obtain an object representation.

Third, the present invention allows information on tracks or object representation to propagate with time from time frame to time frame.

Fourth, the present invention allows for a robust and reliable object perception by using individual sensor configurations, e.g. camera, radar, lidar etc.

Fifth, the present invention leads to an increase of detection ranges around the vehicle and improves performance of the detection system.

According to an example embodiment of the present invention, the first data collecting frame and/or the second data collecting frame is represented by a data collecting window of a fixed length and within a defined time interval during which the data collection of the first sensor and/or the at least second sensor is performed. In this way, an asynchronous data loading in an efficient manner is possible.

According to an example embodiment of the present invention, the first sensor and/or the second sensor is at least one of the following: camera sensor, lidar sensor, radar sensor. In this way, object detection and object classification can be performed in a flexible manner, depending on availability of the sensor equipment in the vehicle.

According to an example embodiment of the present invention, the step of updating of the first object representation and/or the second object representation includes updating a state information of the current first object representation and/or the second object representation at a time t. In this way, the object classification is performed in an efficient manner.

According to an example embodiment of the present invention, during the step of updating the first object representation and/or the second object representation at time t comprising the step of collecting a state information of at least a potential second object at time t. In this way, the object classification and localization is performed in an more efficient manner.

In a second aspect of the present invention, there is provided a vehicle comprising a system implementing the computer-implemented method according of the present invention.

In a third aspect of the present invention, a computer is provided comprising a processor configured to perform the method of the first aspect of the present invention.

In a fourth aspect of the present invention, there is provided a computer program product comprising instructions which, when the program is executed by a processor of a computer, causes the computer to perform the method of any of the first and second aspects of the present invention.

In a fifth aspect of the present invention, a machine-readable data medium and/or download product containing the computer program of the fourth aspect of the present invention is provided.

### BRIEF DESCRIPTION OF THE DRAWINGS

Exemplary embodiments of the present will be described in the following with reference to the figures.

FIG. 1 illustrates a schematic flow-diagram of a computer-implemented method 100 of an example embodiment of the present invention.

FIG. 2 illustrates a schematic concept of the object detection according to an example embodiment of the present invention.

FIG. 3 illustrates a schematic concept of data collection using at least one sensor for object detection of an object according to an example embodiment of the present invention.

FIG. 4 illustrates a schematic detection signal flow of an object detection of an object according to an example embodiment of the present invention.

FIG. 5 illustrates a schematic detection signal flow of an object detection of an object according to an example embodiment of the present invention.

FIG. 6 illustrates a schematic detection signal flow of an object detection of an object according to an example embodiment of the present invention.

### DETAILED DESCRIPTION OF EXAMPLE EMBODIMENTS

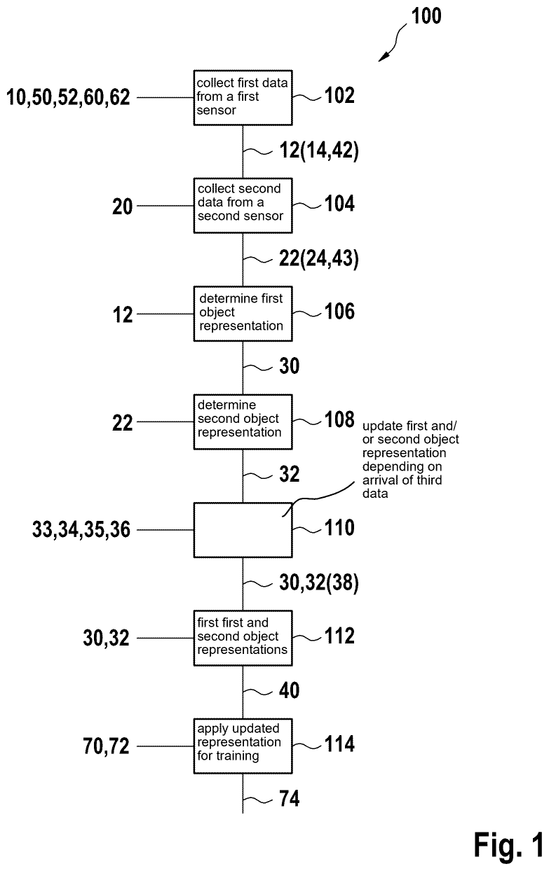

FIG. 1 illustrates a schematic flow-diagram of a computer-implemented method 100 of the present invention for detection of at least one object 50 in an environment 62 of a vehicle 60 using a sensor fusion-based approach and a data-driven model 70. It should be noted that detection of the at least one object 50 may also include classification and/or localization of said object 50.

In a first step 102, first data 12 is collected from a first sensor 10 within a first data collecting frame 14.

In a second step 104, second data 22 is collected from at least a second sensor 20 within a second data collecting frame 24.

As noted before, the present invention can be used for analyzing data obtained from a sensor which may be the first sensor 10 and or the second sensor 20. The sensor 10, 20 may determine measurements of the environment in the form of sensor signals, which may be given by, e.g. digital images, e.g. video, radar, LiDAR, ultrasonic, motion, thermal images, IMU data, GNSS data, etc. Temporal models that align well with realistic use-cases, without any requirements on ordering, timing or availability of the data. Other types of sensors may be used.

In a third step 106, a first object representation 30 is determined using the first data 12.

In a fourth step 108, a second object representation 32 is determined using the second data 22.

In a fifth step 110, the first object representation 30 and/or the second object representation 32 is updated depending on an arrival of third data 36 from the at least second sensor 20 that has been collected in a third data collecting frame 38 after (i.e., later than) the first data collecting frame 14.

Optionally, the step 110 of updating the first object representation 30 and/or the second object representation 32 at time t comprises the step of collecting a state information 35 of at least a potential second object 52 at time t.

Optionally, the updating 110 of the first object representation 30 and/or the second object representation 32 includes updating a state information 33, 34 of the current first object representation 30 and/or the second object representation 32 at a time t.

In a sixth step 112, the first representation 30 and the at least second representation 32 are fused to determine an updated representation 40 of the object 60 based on the received data 12, 14.

In a seventh step 114, the updated representation 40 is applied for training the data-driven model 70 as input data 72 for the data-driven model 70 to obtain output data 74 containing an information about a classification of the detected object 50.

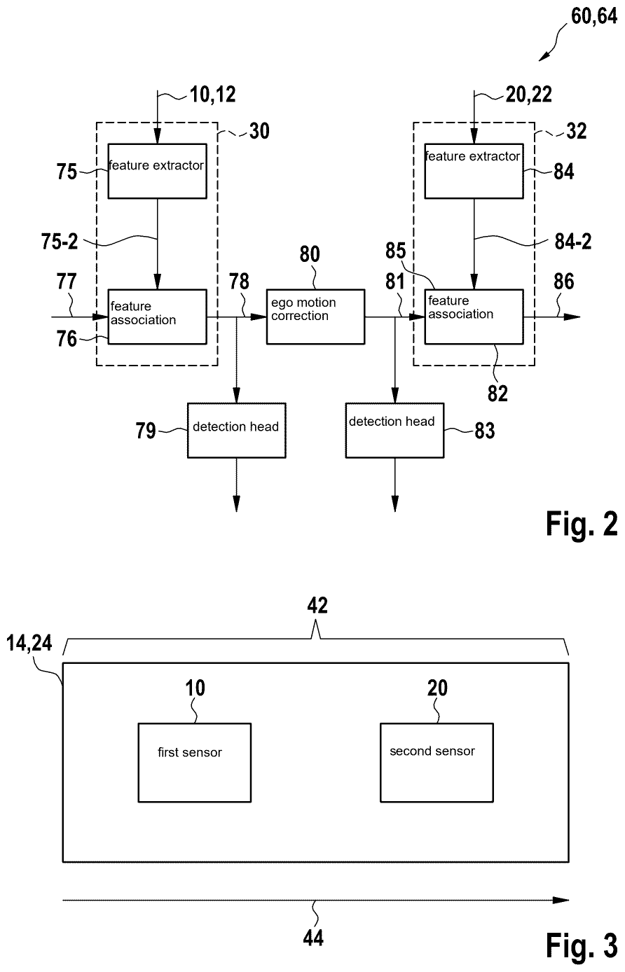

FIG. 2 illustrates a schematic concept or approach of the object detection of an object according to an embodiment of the present invention.

The approach can be applied to a system 64 that is implemented in the vehicle 60.

The predicted tracks or objects 77, which form an object representation of the object 50 from a previous time frame, arrive. Further, the measurements from the first sensor 10, e.g. a radar sensor, arrive. The feature extractor 75 extracts the features 75-2 of this radar data. The object representation 30 may involve the feature extractor 75 and the feature association 76 which may also be an association of an update of the object list representation.

Then an association 76 of the features from previous frames is done and the previous tracks or objects 77 are updated with the current data to obtain updated tracks 78. To these updated tracks, ego motion correction 80 is applied to compensate for the movement of the vehicle 60 and then these tracks are considered ready for the next measurement. In more detail, an Ego motion compensation or correction 80 is applied from a previous time stamp to another time stamp. In addition, a prediction of the location of the object list is performed.

In the following step in FIG. 2, the same is done with the second sensor 20, e.g. a camera, Lidar etc. as described before to obtain an updated track 86 accordingly using the object representation 32 including feature extractor 84 extracting features 84-2 from the sensor data 22 provided by the second sensor 20.

Whenever the data is queried by the downstream tasks in the form of classification of some bounding boxes, a detection head 79, 83 could be applied on top of the predicted or updated tracks 78, 83. Hence, a detection head 79 is applied on the latent representation of the object list to get a localization and classification representation list.

The tracks can be defined as sensor-specific object representations of the object 50 belonging to each sensor that is detected or classified by said sensor.

FIG. 3 illustrates a schematic concept of data collection or a data-loading scheme using at least one sensor for object detection of an object according to an embodiment of the present invention.

As an introduction and in this context, current methods for deep learning (DL) in the context of supervised learning (SL) include some training data and some corresponding labels for training. The training data is fed to the model to produce some model predictions and these predictions are compared to the labels via some loss score. Current SL methods load a batch of data. In current approaches the data batch is represented by data samples that are fixed in length, as the model is aware that the data should arrive at some known time at some known size, e.g. number of images in the case of a video application, etc.

For this, in the related art, an image recognition task for detection an object is described, where data is loaded synchronously to the model. This means that the model usually waits for the CPU to load a pre-defined number of images to the memory. Once this is done, it is passed to the model (either directly or to the GPU and then to the model). The disadvantage of this approach here is that the model waits for the data, and once the data is loaded, the model is activated. This results an inefficient process of object detection.

However, in case of training a multi-modal model, data is loaded simultaneously from many sensors. In this case, a data-batch is loaded that contains data for all required sensors that are synchronized to one time-stamp. The data types that are loaded are typically defined by the model requirements. Eventually, the multi-modal data is fed synchronously to the model, which assumes that all data refer to a single timestamp.

There, all the sensors are loaded within one batch that includes all the data from all the sensors but there the data is considered for one time stamp. Then the data that is considered to correspond to one time stamp is fed to the model. There, again, the data is considered to relate to a single timestamp. This known approach makes the process of image recognition for detecting an object inefficient and restricts the capabilities of each sensor used in the system for detecting the object in an unduly manner.

Therefore, in the present invention, a data-loading scheme is introduced how data from different sensors (see FIG. 2) are processed in an efficient manner, so that the advantages of each sensor used are fully incorporated when detecting an object in the environment of an vehicle.

The solution of the present invention for this problem is depicted in FIG. 3 (with combination of FIG. 2).

The data-loading scheme loads data from multiple sensor sources that lie within a fixed time interval. Therefore, a fixed number of measurements per source, nor the same amount among all sensor sources is required.

In respect to FIG. 3, this data-loading scheme is implemented in that the first data collecting frame 14 and/or the second data collecting frame 24 is represented by a data collecting window 42 with of a fixed length, e.g. a time t_{seq} of 300 ms, and within a defined time interval during which the data collection of the first sensor 10 and/or the at least second sensor 20 is performed. The arrow 44 gives a chronical order of collecting the data from the various sensor types.

In this way, compared to the known prior art approach, the present invention uses an asynchronous data-loading scheme to process data from different sensor types for detecting an object by building multiple object representations of the object to be detected, wherein the multiple object representations of the object are then merged or fused to obtain a final object representation of the object.

In the following, an example with regard to FIG. 3 is provided for the data-loading mechanism for sensor fusion of the present invention:

Within a window of t_{seq}=300 ms for example, the data was available from two different sensors to formulate a sample: 2 samples from sensor 10 (e.g. Lidar1), 2 samples from type 2 sensor 20 (e.g. Camera1). The advantage of this data-loading scheme is that it can load a non-constant and non-consistent number of samples for each sensor, while existing data-loaders do use this assumption.

According to this approach, the data arrives at the network as a batch containing variable length of multi-modal temporal samples within a specified time window (for example 300 ms). A batch in the sense of the present invention is a batch containing variable length of multi-modal temporal samples (for example, sample1, sample2, sample3 for batch size 3).

In this regard, further aspects of this embodiment of the present invention are presented in the following.

As mentioned before, the context of present invention is to get the ability to train a neural network using data that is not synchronized and where the batch size is constant, but the length of the samples within a batch is not constant.

Contrary, in known prior art approaches, sensor fusion is usually based on a soft (non-regular) grid approach, where the detection head is an attention based one. There, the data is assumed to be synchronized.

In the context of the present invention, non-synchronized data is used rather than the prefect data tuples. Hence, the present invention is about asynchronous data loading for sensor fusion. A further aspect of the present invention is the loading some individual sensory data for training a single or multiple neural networks (NN) for some task. In the present invention, these NNs are used for object detection (OD), but the present invention is not be restricted to this case only. Here, data is loaded to the model in an asynchronous manner. Instead of loading data that is either synchronous (matches in timestamp) or is aligned to match a certain timestamp, a data-loading scheme is proposed that loads sequential data that refer to measurements that origin from different points in time. Further our scheme does not synchronize data by any means of post-processing and does not expect a fixed number of measurements to be loaded.

This general approach can be expressed in a more formal manner:

Given N sensor data sources, we select one source as the reference. Following, a time window t_{seq} is provided that defines the sequence length (in time) that should be loaded.

For any measurement of the reference source, the data from all sensor data sources is loaded that lie in the time interval t ∈ [t_{ref}−t_{seq, tref}], where t_{ref} defines the timestamp of the reference measurement. The collected data is herein defined as a sample. It must be noted, that the existence of data for a requested data source within the time interval is not required, and a fixed number of measurements among the sensor sources is not expected either.

It is further noted that the loaded data within the time interval holds data from all data sources as a sample. For training neural networks multiple samples are loaded and arranged into sets which is called batching. The present invention is meant to provide a data-loading solution for asynchronous multi-modal perception systems that use a neural network at its core. Thus, the present invention enables to train perception networks that are compatible for real use-cases where data arrives the system asynchronously and on an inconsistent basis. This can include data dropout, different sensor update frequencies or multi-modal sensor capturing that does not follow a specific order.

It should be further noted that the present approach for loading data is also applicable to the unsupervised learning (USL) case, where the data is loaded but the training labels do not exists. Moreover, our approach is applicable to the case of self-supervised learning (SSL), where the model generates the labels for training by itself.

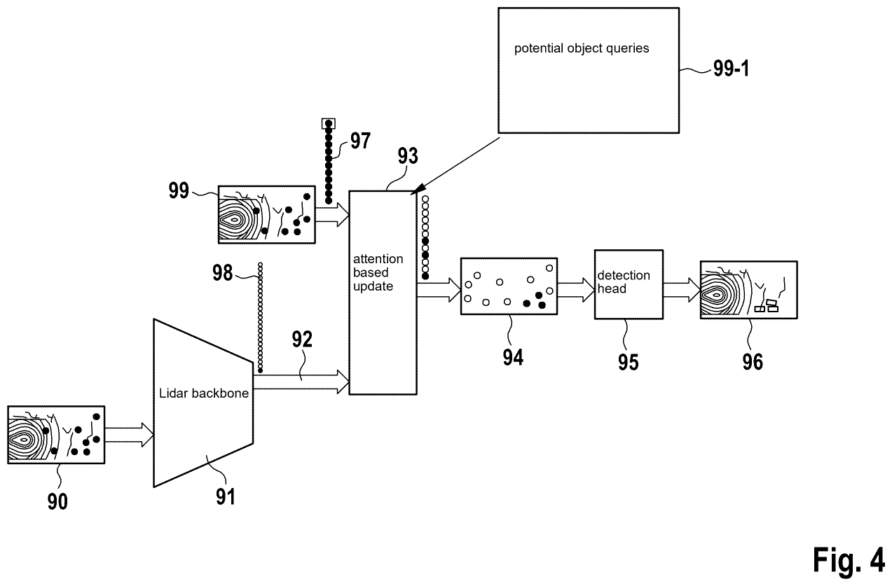

FIG. 4 illustrates a schematic detection signal flow of an object detection of an object according to an embodiment of the present invention.

FIG. 4 shows in detail an attention-based detector to implement the detection approach of the present invention in a further example.

Data 90 from a Lidar is acquired in the form of a point cloud (PC) as dataₜ at a time t. The PC is processed by a Lidar backbone 91 to form a Lidar feature map feature, 92. This is a latent space representation of this lidar scan. Additionally, positional encoding 98 may be performed.

In addition, potential object queries 99-1 are obtained from the same lidar scan using some algorithm to guess where potential objects 99 might be. This algorithm could vary from random initialization (a very simple one) to more complex one like farthest point sampling. Optionally, the queries 99-1 are from the objₜ^{potential} and wherein the queries 99-1 may include keys that are from the feature to formulate that attention vector as stated, i.e. Aₜ=Attention (Key=featureₜ, Query=objₜ^{potential}), wherein the each Key has a corresponding value.

The potential objects 99 at time t, including some positional encoding objₜ^{potential} are then fed to the attention based update 93 together with the current data feature, 92. The output 94 of this attention mechanism are objects that were detected in this lidar scan, i.e. objₜ^{potential} or stateₜ/state information at time t. If a detection head 95 will be applied on this stateₜ a bounding box (bbx) representation 96 at time t of this lidar scan can be extracted. If not, this map will be kept as the state (stateₜ) for future usage, e.g., as prior to the next time tracking or any other usage.

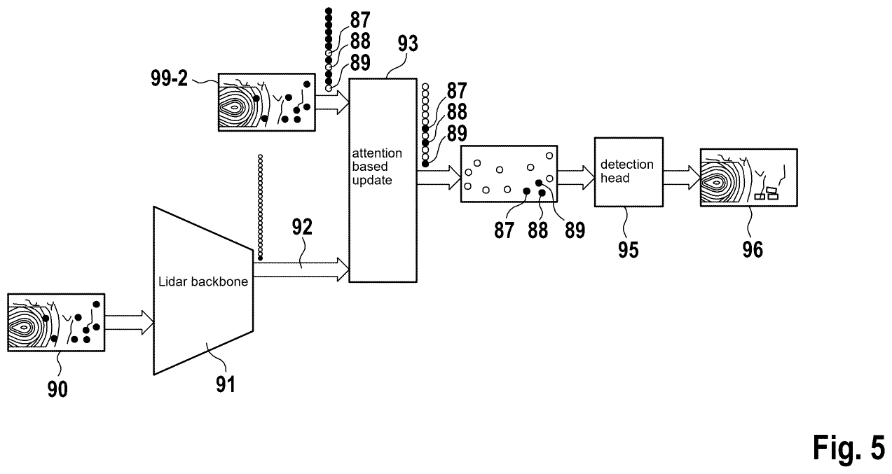

FIG. 5 illustrates a schematic detection signal flow of an object detection of an object according to an embodiment of the present invention. Therein, the same mechanism as described in FIG. 4 is shown, but now in a different context.

This time, some of the candidates for detections are considered for tracking as objₜ^{detections} t are passed to the next time stamp (t+1) as queries. Here, objects 87, 88, 89 were detected as objects to be tracked at time (t+1).

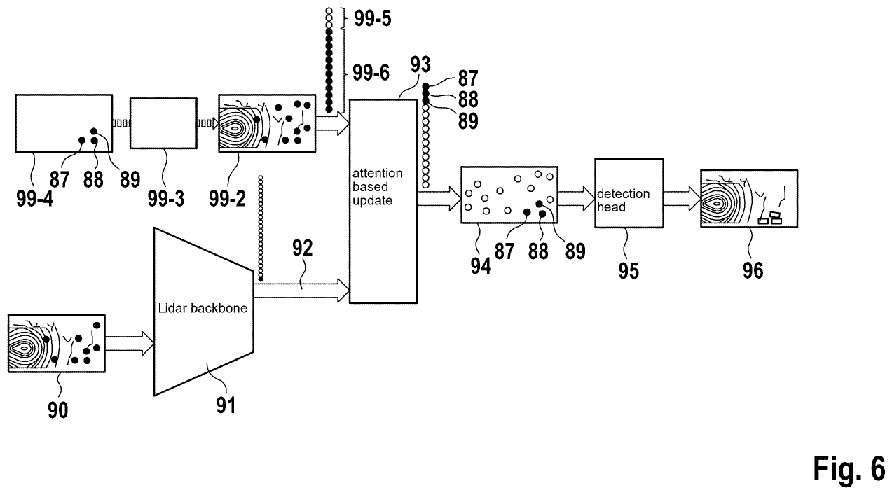

FIG. 6 illustrates a schematic detection signal flow of an object detection of an object according to an embodiment of the present invention.

The FIG. 6 presents the full cycle of the detection and tracking:
(i) Here, updated tracks at time t state₁^{updated} objects 87, 88, 89 that were detected and tracked at time t+1 (see box 94) are the input from the previous time. These stateₜ^{updated} tracks are then ego motion corrected and updated by some prediction movement model to be part of the predicted state at time (t+1), i.e. stateₜ₊₁^{pred}. The remaining potential tracks for time (t+1) are derived by the same algorithm that was described above (random sampling, farthest point sampling, or any other). In total, the potential tracks are formed by stacking propagated tracks stateₜ₊₁^{pred} and potential new tracks objₜ^{potential}.
(ii) In addition, the dataₜ₊₁ is acquired by the sensor and processed by the lidar backbone to produce the data features at time (t+1), i.e. featureₜ₊₁.
(iii) Attention-based mechanism is applied as described before:
Aₜ₊₁=Attention(Key=featureₜ₊₁, Query=stateₜ₊₁^{pred}, values are, again, from the Keys.
(iv) The output of this Attention mechanism in the context of tracking are updated objects stateₜ₊₁^{updated}. This latent space representation of the state can then be passed as tracks for the next time cycle and can be inputted to the detection head for bbx extraction.

The same principle as described in FIG. 4 to 6 applies for Radar PC and Camera features that were projected to the BEV 3D by some method.

What is claimed is:

1. A computer-implemented method for classification of at least one object in an environment of a vehicle using a sensor fusion-based approach and a data-driven model, comprising the following steps:
collecting first data from a first sensor within a first data collecting frame;
collecting second data from at least a second sensor within a second data collecting frame;
determining a first object representation using the first data;
determining a second object representation using the second data;
updating the first object representation and/or the second object representation, depending on an arrival of third data from the at least second sensor that has been collected in a third data collecting frame after the first data collecting frame;
fusing the first object representation and the at least second object representation to determine an updated representation of the object based on the collected first and second data;
applying the updated representation for training the data-driven model as input data for the data-driven model to obtain output data containing an information about a classification of the detected object.

2. . The computer-implemented method according to claim 1, wherein the first data collecting frame and/or the second data collecting frame is represented by a data collecting window of a fixed length and within a defined time interval during which data collection of the first sensor and/or the at least second sensor is performed.

3. The computer-implemented method according to claim 1, wherein the updating of the first object representation and/or the second object representation includes updating a state information of a current first object representation and/or current second object representation at a time t.

4. The computer-implemented method according to claim 1, wherein during the step of updating the first object representation and/or the second object representation at time t, a step of collecting a state information of at least a potential second object at time t is performed.

5. A vehicle, comprising:
a system for classification of at least one object in an environment of a vehicle using a sensor fusion-based approach and a data-driven model, the system configured to:
collect first data from a first sensor within a first data collecting frame,
collect second data from at least a second sensor within a second data collecting frame,
determine a first object representation using the first data,
determine a second object representation using the second data,
update the first object representation and/or the second object representation, depending on an arrival of third data from the at least second sensor that has been collected in a third data collecting frame after the first data collecting frame,
fuse the first object representation and the at least second object representation to determine an updated representation of the object based on the collected first and second data, and
apply the updated representation for training the data-driven model as input data for the data-driven model to obtain output data containing an information about a classification of the detected object.

6. A computer, comprising:
a processor configured to perform a computer-implemented method for classification of at least one object in an environment of a vehicle using a sensor fusion-based approach and a data-driven model, including the following steps:
collecting first data from a first sensor within a first data collecting frame,
collecting second data from at least a second sensor within a second data collecting frame,
determining a first object representation using the first data,
determining a second object representation using the second data,
updating the first object representation and/or the second object representation, depending on an arrival of third data from the at least second sensor that has been collected in a third data collecting frame after the first data collecting frame,
fusing the first object representation and the at least second object representation to determine an updated representation of the object based on the collected first and second data,
applying the updated representation for training the data-driven model as input data for the data-driven model to obtain output data containing an information about a classification of the detected object.

7. A non-transitory machine-readable data medium on which is stored a computer program for classification of at least one object in an environment of a vehicle using a sensor fusion-based approach and a data-driven model, the computer program, when executed by a computer, causing the computer to perform the following steps:
collecting first data from a first sensor within a first data collecting frame;
collecting second data from at least a second sensor within a second data collecting frame;
determining a first object representation using the first data;
determining a second object representation using the second data;
updating the first object representation and/or the second object representation, depending on an arrival of third data from the at least second sensor that has been collected in a third data collecting frame after the first data collecting frame;
fusing the first object representation and the at least second object representation to determine an updated representation of the object based on the collected first and second data;
applying the updated representation for training the data-driven model as input data for the data-driven model to obtain output data containing an information about a classification of the detected object.
